(19) United States
(12) Patent Application Publication
(10) Pub. No.: US 2024/0070608 A1
(43) Pub. Date: Feb. 29, 2024

(54) RESOLVING MISPLACED ITEMS IN PHYSICAL RETAIL STORES

(71) Applicant: Micron Technology, Inc., Boise, ID (US)

(72) Inventors: Saideep TIKU, Folsom, CA (US); Poorna KALE, Folsom, CA (US)

(21) Appl. No.: 17/823,728

(22) Filed: Aug. 31, 2022

(51) Int. Cl. G06Q 10/08; G06Q 30/02; G06Q 30/06

(52) U.S. Cl. CPC G06Q 10/087; G06Q 30/0208; G06Q 30/0281; G06Q 30/0639

(57) ABSTRACT

In some implementations, an extended reality (XR) device may receive, from a server, a request to resolve an item that is misplaced in a physical retail store, wherein the request indicates a misplaced location associated with the item. The XR device may provide, via an interface, a notification of the request, wherein the notification includes an option to accept the request. The XR device may receive, via the interface, an indication that the request has been accepted. The XR device may transmit, to the server, the indication that the request has been accepted. The XR device may provide, via the interface, an in-store navigation path to direct a user of the XR device via overlayed audio-visual cues to the misplaced location to pick up the item.

### TECHNICAL FIELD

The present disclosure generally relates to extended reality (XR) devices and, for example, resolving misplaced items in physical retail stores.

### BACKGROUND

Extended reality (XR) may blend a physical world (or real world) and a virtual world (or digital world) to create a more personalized, immersive visual experience. XR may encompass augmented reality (AR), mixed reality (MR), and virtual reality (VR). AR may provide an interactive experience of a physical-world environment, in which objects that reside in the physical world may be enhanced by computer-generated perceptual information. MR may merge physical and virtual worlds to produce new environments and visualizations, in which physical and digital objects may co-exist and interact in real time. VR may provide a fully virtual world without an intervention of the physical world. XR may be across multiple sensory modalities, including visual, auditory, haptic, somatosensory, and/or olfactory. XR may be useful across a wide variety of applications, such as gaming, healthcare, retail, customer service, and/or manufacturing.

### BRIEF DESCRIPTION OF THE DRAWINGS

FIGS. 1A-1D are diagrams of an example related to resolving misplaced items in physical retail stores.

FIGS. 2-4 are diagrams of examples related to resolving misplaced items in physical retail stores.

FIG. 5 is a diagram illustrating an example environment in which systems and/or methods described herein may be implemented.

FIG. 6 is a diagram of example components of one or more devices of FIG. 5.

FIGS. 7-9 are flowcharts of example processes relating to resolving misplaced items in physical retail stores.

### DETAILED DESCRIPTION

An item for sale in a physical retail store may be intentionally or unintentionally moved between locations, which may cause the item to be misplaced. For example, a customer in the physical retail store may pick up the item from a shelf and place the item on another shelf in the physical retail store. For example, the customer may pick up the item from the shelf and place the item in a shopping cart, and at a later time, the customer may decide that the item is no longer needed. The customer may place the item at a nearest shelf rather than walking back to the shelf on which the item was originally located. When placing the item on the nearest shelf, the item may now be with other unrelated items.

This situation may cause another customer, who is looking for the item, to be unable to find the item. When the item is not on the shelf intended for that item, the other customer may mistakenly believe that the item is no longer available at the physical retail store. The other customer may ask an employee of the physical retail store whether the item is available, but the employee may also be unaware that the item has been misplaced. Furthermore, since the employee may be unaware that the item has been misplaced, the misplaced item may not be moved back to the shelf in a timely manner. A realization that the item has been misplaced may occur only when the employee performs a manual check of each shelf (e.g., at the end of the day), and then moves back any misplaced items to their appropriate locations. As a result, a lengthy delay may result between a time at which the item is misplaced and a time at which the item is moved back to the appropriate location, and during this lengthy delay, the misplaced item may be unavailable for sale. Certain shelves may appear cluttered with mismatched items, which may cause other customers to form a poor opinion of the physical retail store, and which may cause the other customers to decide to shop at another physical retail store that does not have cluttered shelves. An inventory of the item may be inaccurate. The employee may mistakenly believe that a quantity associated with the item is a lower value, since the employee may be unaware that the item is actually in the physical retail store but is misplaced on another shelf. Further, inventory equipment may be used for longer periods of time to take into account adjustments that need to be made to scan for misplaced items, which may result in wasted computing resources and battery life, as well as wasted computing resources having to correct inventory orders once misplaced items are located. Additional shortcomings may involve an employee cost that is consumed in finding and returning misplaced items to their correct location, inventory cost that is lost by misplaced items going bad and becoming unsellable before being found and purchased or returned to their correct location, and/or wear and tear on restocking equipment to restock shelves that might not have to be restocked because there are misplaced items that belong on those shelves.

In some implementations described herein, to solve the shortcomings described above, as well as detecting misplaced items within a physical retail store and returning the misplaced items to appropriate locations, a solution is described herein for detecting an item that has been misplaced within the physical retail store using a camera that is a part of a network of cameras installed throughout the physical retail store. The camera may detect, based on an image captured by the camera, that the item has been misplaced in the physical retail store. The item may be in a field of view of the camera. The camera may transmit, to a server, an indication that the item has been misplaced. The indication may indicate other various information as well, such as an identity of a misplaced location associated with the item, an identity of the item, and/or an identity of a person that misplaced the item. “Misplaced location”, as used herein, refers to a location of an item that is in a different location relative to other identical items or other similar items. The misplaced location may refer to a location that differs from an expected, or assigned, location of the item. The server may receive the indication from the camera. The server may select an extended reality (XR) device within the physical retail store, where the XR device may be worn (or carried) by a user. The user may be a customer shopping in the physical retail store. The server may select the XR device based on a list of items to be purchased by the user. The server may select the XR device based on a current location of the XR device in relation to the misplaced location associated with the item. The server may transmit, to the XR device, a request to resolve the item that is misplaced in the physical retail store. The item that is misplaced may be resolved by moving the item to an appropriate location, or by retrieving the item from the misplaced location and purchasing the item. “Appropriate location”, as used herein, refers to a location at which the item is supposed to be located (e.g., a correct location associated with the item, or a location associated with other identical items or other similar items).

In some implementations, the XR device may provide, via an interface of the XR device, a notification of the request, where the notification may indicate an incentive for accepting the request. The incentive may be a discount associated with purchasing the item, a coupon, a store credit, and/or reward points, among other examples. When the request is accepted, the XR device may provide, via the interface, an in-store navigation path to direct the user of the XR device via overlayed audio-visual cues to the misplaced location to pick up the item. The XR device may generate the in-store navigation path based on store mapping information, which may indicate a map of store aisles and corresponding items that are available for sale in the store aisles. The item may be picked up from the misplaced location and added to a shopping cart for purchase, or the item may be returned to the appropriate location, which may result in the user being awarded the incentive. The XR device may generate the in-store navigation path to the appropriate location using the store mapping information.

In some implementations, misplaced items may be moved back to appropriate locations in a relatively fast manner. Cameras in the physical retail store may detect items which are misplaced after the items are placed onto a shelf with different items. For example, a camera may detect when a bag of chips is placed on a shelf with bags of cookies, and the camera may notify the server. The server may select which XR device is best suited to resolve a misplacement of the item, and the server may transmit a request to the XR device. Adding the incentive may entice a user of the XR device to resolve the misplacement of the item. When the server receives an indication from the XR device that the request is not accepted, the server may select a next best XR device to resolve the misplacement of the item. As a result, misplaced items may be corrected in a relatively fast manner. Employee resources may not be wasted in correcting misplaced items. The physical retail store may reduce costs by offering incentives to customers to fix misplaced items instead of utilizing the employee resources, which may be better served in other areas.

In some implementations, the camera in the physical retail store may provide a real-time inventory management system that accurately determines whether items are still in inventory. For example, conventional systems may assume that a misplaced item has been lost or stolen when the item may merely be misplaced. The camera may identify misplaced items such that the misplaced items may be confirmed as still being in inventory. Additionally, the XR device may generate a real-time navigation path from the misplaced location to the item's proper location. The XR device may relay the navigation path to an identified user. The real time inventory system may save computation cycles, communication bandwidth, etc., because additional items are not ordered, erroneous calculations are avoided, and outdated data is not stored in memory.

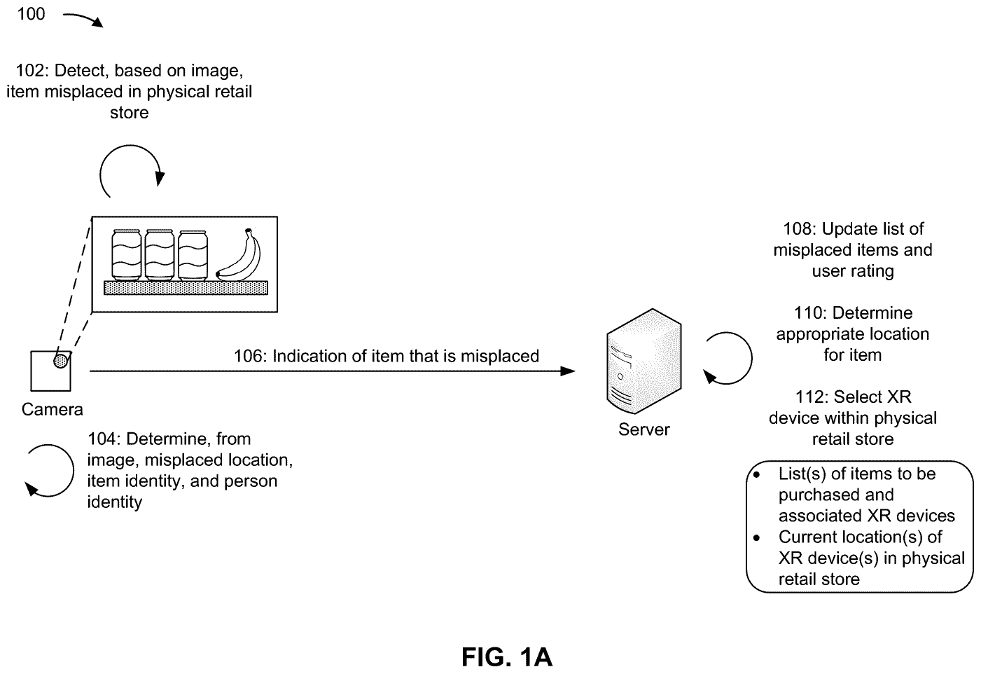

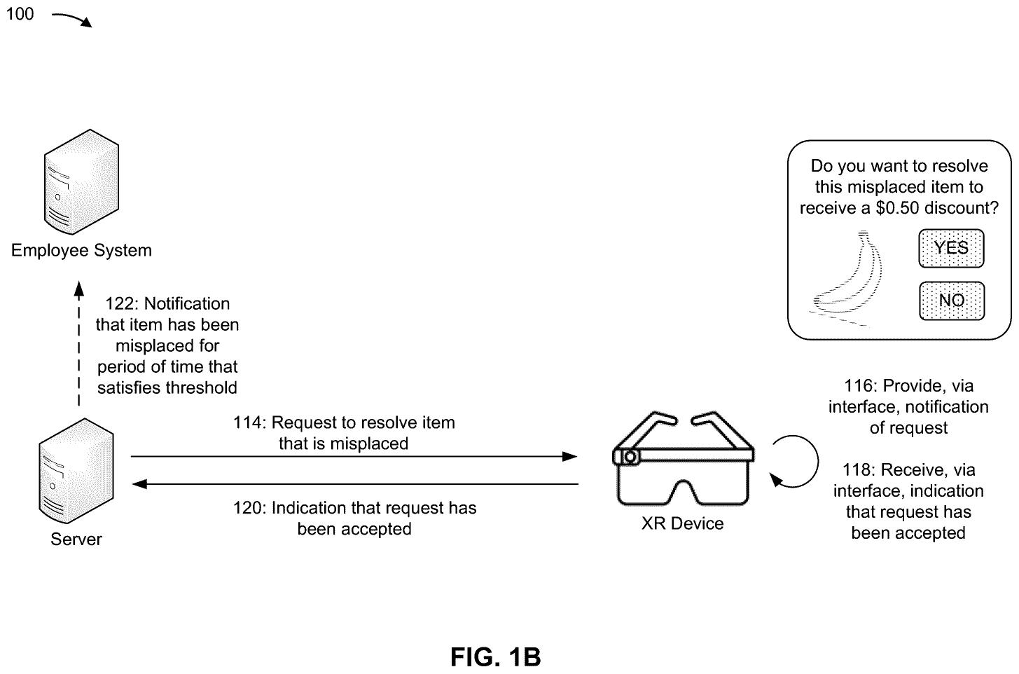

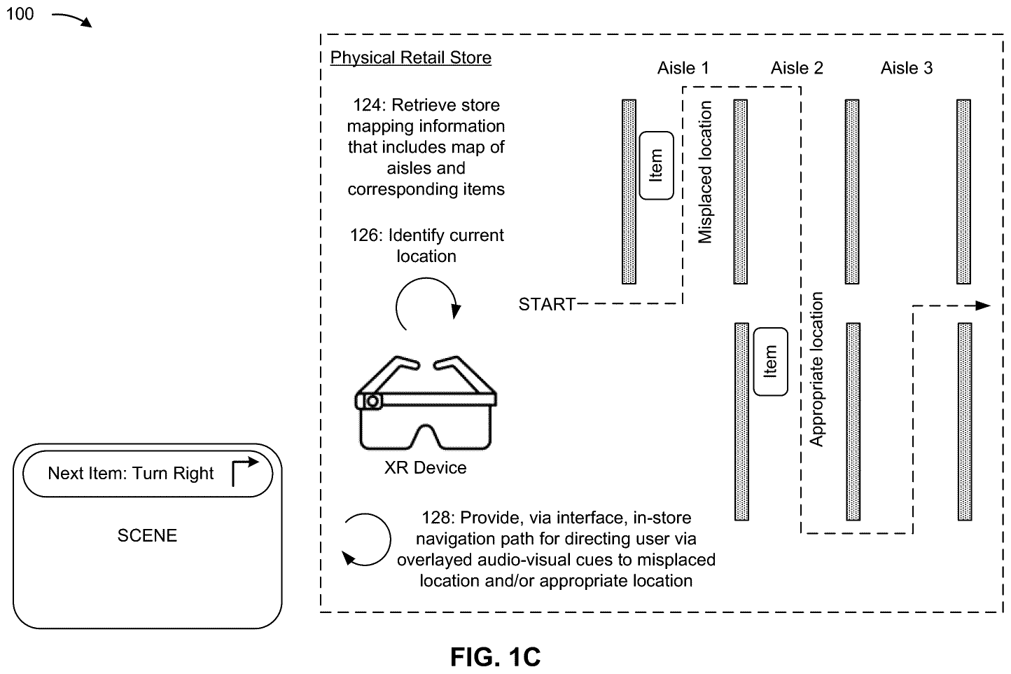

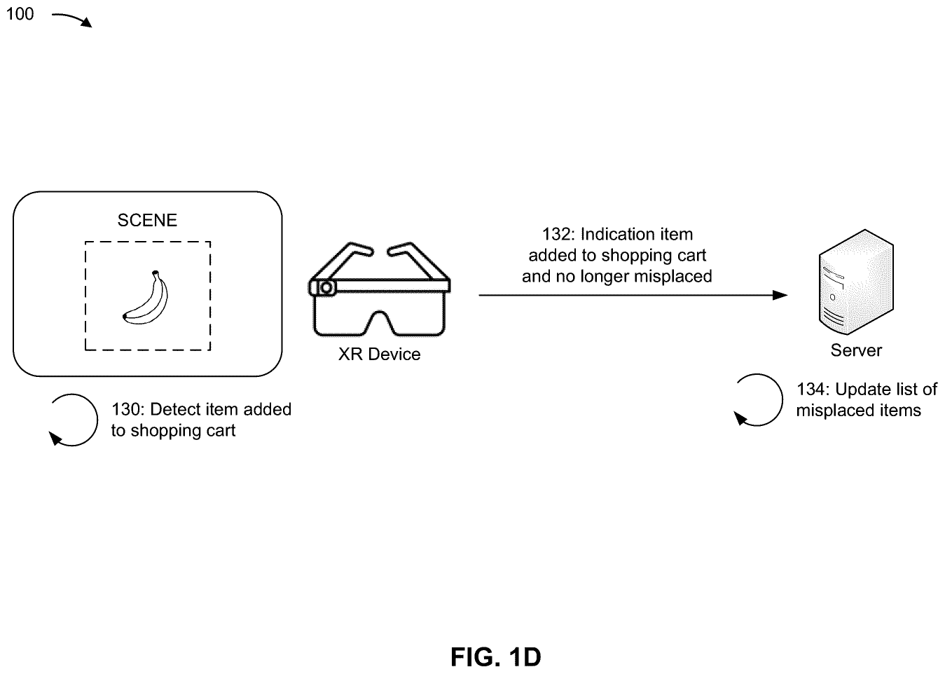

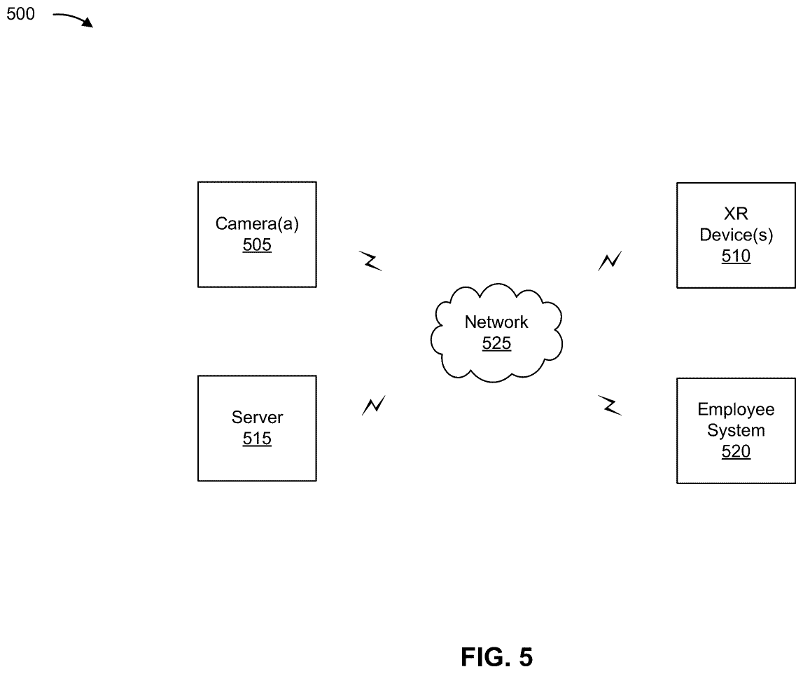

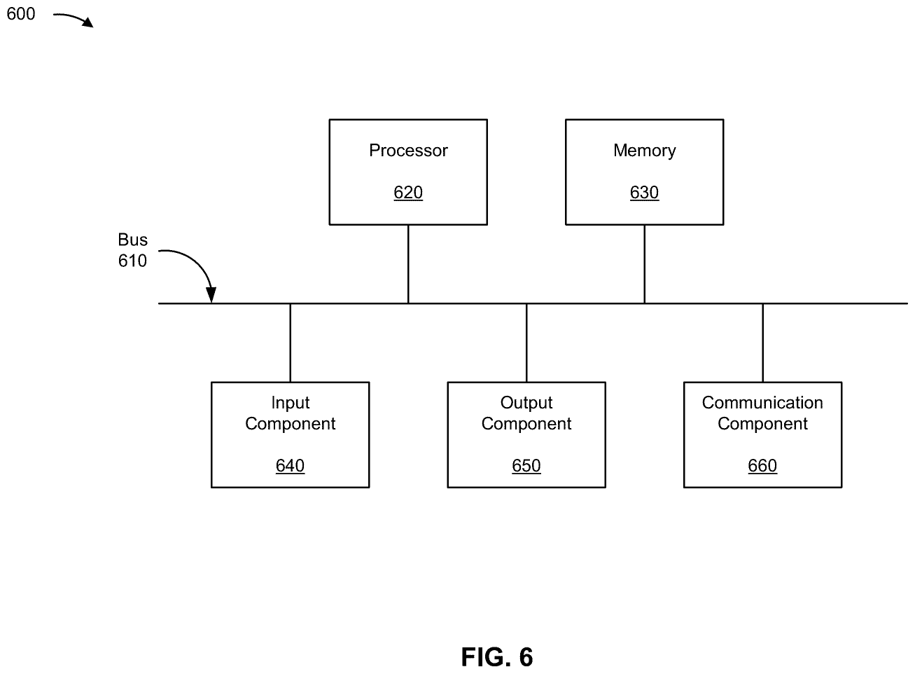

FIGS. 1A-1D are diagrams of an example 100 related to resolving misplaced items in physical retail stores. As shown in FIGS. 1A-1D, example 100 includes a camera, an XR device, a server, and an employee system. These devices are described in more detail in connection with FIGS. 5 and 6.

In some implementations, the cameras may be installed throughout a physical retail store. The cameras may be responsible for monitoring items on aisles and customers who pick up the items and place the items into shopping carts. The cameras may be smart cameras capable of detecting objects and movements of objects. The cameras may be conventional cameras with backend processing to perform image analysis and/or motion tracking. In some implementations, the XR device may be a head-mounted display worn by a user. Alternatively, the XR device may be a mobile device carried by the user. The XR device may provide augmented reality (AR), mixed reality (MR), and/or virtual reality (VR) capabilities. In some implementations, the server may be associated with a cloud computing system or an edge computing system. In some implementations, the employee system may be a device associated with an employee of the physical retail store.

In some implementations, the camera, the XR device, and/or the server may support a deep learning accelerator (DLA). The DLA may be a hardware architecture designed and optimized for increased speed, efficiency, and accuracy when running deep learning algorithms, such as convolutional neural networks (CNNs), recurrent neural networks (RNNs), generative adversarial networks (GANs), and others. The DLA may enable inference tasks to be performed more rapidly and using less energy as compared to general-purpose computers.

In some implementations, the DLA may by supported/used for processing and learning with respect to various tasks. Such tasks, which are further described herein, may include determining, using a camera of the XR device, a current location within the physical retail store; detecting, via the camera, that an item is added to a shopping cart; detecting, using the camera, that the item has been misplaced on a shelf of a physical retail store; and/or determining an appropriate location for the item based on store mapping information.

As shown in FIG. 1A, and by reference number 102, the camera may detect, based on an image captured by the camera, that an item in a field of view of the camera has been misplaced in the physical retail store. The item may be a grocery item, apparel, electronics, or any other item that may be purchased at the physical retail store. The camera may be a fixed camera, or the camera may be a mobile camera (e.g., the camera may be attached to a robot that moves down aisles and takes images of shelves on the aisles). The robot may be attached on rails on the ceiling and have multiple cameras (e.g., one per shelf). The robot may be on the floor and traverse a path. The robot may be attached to a particular shelf in a particular aisle and periodically run back and forth up and down the aisle. The robot may have front-facing and back-facing cameras to capture images of items on the shelf the robot is attached to and the shelf on the other side of the aisle. In some cases, a combination of fixed cameras and robot cameras may be used, where the fixed items may be used to monitor for people putting items on shelfs and the robot mounted cameras may be used to identify identities of items put on the shelves.

In some implementations, the camera may take the image of items on a shelf, where the items on the shelf may be in the field of view of the camera. The camera may process or analyze the image using object recognition, image recognition, machine vision, or other related techniques. The camera may detect that the item has been misplaced on the shelf based on a difference between the item and surrounding items on the shelf. For example, the camera may detect, from the image, that one item is different from nearby other items on the shelf. For example, the misplaced item may have different characteristics (e.g., height, width, shape, color, etc.) as compared to other items proximate to the misplaced item on the shelf. In some implementations, the camera may analyze multiple time-lapsed images of the shelf, which may show the misplaced item being placed on the shelf. For example, the multiple time-lapsed images may show ten similar items on the shelf and then a different item being placed on the shelf next to those ten similar items. As a result, the camera may detect when the item has been misplaced in the physical retail store.

In some implementations, in order to detect that the item has been misplaced, the XR device may look up, in a database, information associated with the items that are supposed to be on a given shelf. The database may indicate a shape associated with the items, a size associated with the items, colors associated with the items, etc. The XR device may compare items detected in the image to the information, and the XR device may determine when one of the items from the image does not match with the information, thereby indicating that the item is misplaced. In some implementations, the XR device may perform an optical character recognition (OCR) on the image, and the XR device may determine if similar words are repeated within a group of items. When the XR device detects, from the image, an item in the group of items that does not have similar wording as compared to other items in the group of items, the XR device may determine that the item has been misplaced.

As shown by reference number 104, the camera may determine, from the image, a misplaced location associated with the item. The camera may use object recognition or other related techniques to detect signs (e.g., aisle sign numbers) in the image, from which the camera may determine the misplaced location associated with the item. In some implementations, the camera may determine the misplaced location associated with the item based on a known location of the camera. The camera, when fixed at the known location, may be associated with a particular aisle and/or shelf. The camera may be configured to capture images of only the particular shelf and/or aisle. In this case, any images captured by the camera may be tagged with a particular aisle number and/or shelf number. When the camera is fixed, the aisle may be known based on the camera's location. In some cases, when the camera is not fixed (e.g., the camera is attached to a robot), the aisle may be known from the path that the robot is configured to follow, the time at which the image is captured, and the time at which the robot started traversing the path.

In some implementations, the camera may determine, from the image, an identity associated with the item. For example, the camera may perform an item recognition and determine an item name for each item shown in the image, and based on the item recognition, the camera may determine when one item is different from other items on the shelf. The camera may detect, from the image, a product code, a barcode, a quick response (QR) code, a label, branding, or some other identification information associated with the item, from which the camera may determine the identity associated with the item. The identity associated with the item may indicate a type of item (e.g., a box of cereal), and in some cases, the identity associated with the item may indicate a more specific type of item (e.g., a box of cereal of a particular kind).

In some implementations, the camera may determine, from the image, the identity of a person (or an identifier associated with a person, such that the person may remain anonymous) that misplaced the item. The image may depict the person that misplaced the item, and based on a face recognition or a related technique, the camera may determine the identity of the person. The camera may determine a user tag or unique identifier associated with the person. The camera may be configured to detect persons associated with misplaced item events, but the camera may not capture other events associated with the person for privacy reasons. The camera may access a database of face profiles for a plurality of users to determine the identity of the person. In some cases, when identity detection is unable to be made of the person with an accuracy that satisfies a threshold (e.g., 98%), the identity of the person may not be used to avoid falsely identifying a person of misplacing the item (e.g., false positives).

As an example, the camera may capture images of a shelf containing soda cans. The camera may capture the images with a certain frequency (e.g., every minute, every 10 minutes, or so on). In one of the images, the camera may detect that an item has been misplaced on the shelf among the soda cans. The camera may detect the misplacement of the item based on the item having different features or characteristics as compared to other items on the shelf. The camera may determine a misplaced location (e.g., a particular aisle number and/or shelf number) associated with the item. The camera may determine that the item that is misplaced is a banana. The misplaced location may indicate a location at which the item was placed, where the location is not supposed to have such items and instead has different items. In some cases, the camera may determine an identity of a person that misplaced the banana on the shelf.

In some implementations, the camera may be triggered based on a person being detected as entering the aisle. For example, if a person is detected as entering the aisle, the camera may monitor the person's activity in that aisle to determine whether the person puts an item on a shelf. If the person does put an item on the shelf, the camera may capture an image of the shelf to determine whether a misplaced item is present. This approach may conserve camera resources associated with capturing and analyzing images that would have otherwise been used to periodically capture images when no changes to the items in the aisle occurred.

As shown by reference number 106, the camera may transmit, to the server, an indication of the item that has been misplaced. The indication may identify the misplaced location associated with the item. The indication may include the identity associated with the item. The indication may include the identity of the person that misplaced the item. In some implementations, the indication may not indicate the identity of the misplaced location, and instead the server may determine the identity of the misplaced location on the backend by processing the image captured by the XR device. In this case, the XR device may transmit the image to the server. In some implementations, the indication may not indicate the misplaced location associated with the item, and instead the server may determine the misplaced location based on a known location associated with the camera and a known field of view associated with the camera. The server may receive, from a database, an indication of the known location associated with the camera and the known field of view associated with the camera.

In some implementations, the camera may transmit only the image to the server. The server may determine, from the image, the misplaced location associated with the item. The server may determine, from the image, the item identity associated with the item. The server may determine, from the image, the identity of the person that misplaced the item. In this case, image processing may be offloaded from the camera to the server, which may save resources at the camera.

As shown by reference number 108, the server may receive the indication, and the server may update a list of misplaced items. The server may maintain the list of misplaced items for the physical retail store. In some implementations, when the indication includes the identity of the person that misplaced the item, the server may update a rating associated with the person. For example, the server may lower the rating associated with the person because the person misplaced the item.

As shown by reference number 110, the server may determine an appropriate location for the item based on the identity of the item and store mapping information. The store mapping information may indicate a map of store aisles and corresponding items that are available for sale in the store aisles. For example, based on the store mapping information, the server may determine that the banana should be placed on aisle 5 instead of aisle 9. The appropriate location may indicate where like items are held in the physical retail store.

As shown by reference number 112, the server may select an XR device within the physical retail store. The server may select the XR device to receive a request to resolve the item that is misplaced. The server may select which XR device should receive the request based on various factors. In some implementations, the server may receive, from a plurality of XR devices associated with users that are shopping at the physical retail store, lists of items to be purchased from the physical retail store. The server may determine that these XR devices are currently in the physical retail store. The server may not select XR devices associated with users that have already left the physical retail store. The server may select an XR device, from the plurality of XR devices, to receive the request based on the item being misplaced being included in a list of items to be purchased by a user wearing (or carrying) the XR device. In other words, the user associated with the XR device may already intend to purchase the item that is misplaced, as indicated by their list of items to be purchased, so the user may be provided with an option to purchase the item that is misplaced.

In some implementations, the server may receive, from a plurality of XR devices associated with users that are shopping at the physical retail store, the lists of items to be purchased from the physical retail store. The server may select an XR device to receive the request, from the plurality of XR devices, based on the item being misplaced being within a certain distance from a location of an item included in a list of items to be purchased by a user wearing (or carrying) the XR device. In other words, the user associated with the XR device may already intend to purchase an item that is relatively close to (e.g., same aisle) the item that is misplaced, as indicated by their list of items to be purchased, so the user may be provided with an option to pick up the item that is misplaced. Further, the user may intend to purchase an item that is relatively close to (e.g., same aisle) the appropriate location for the item that is misplaced, so the user may be provided with the option to drop off the item at the appropriate location. For example, an XR device associated with a user that is only going to be in a grocery aisle may not be requested to resolve an electronics item.

In some implementations, the server may detect a plurality of XR devices associated with users that are shopping at the physical retail store. The server may detect a current location for each of the plurality of XR devices. The server may calculate distances between current locations of XR devices, misplaced locations associated with the items, and appropriate locations for the items. The server may select an XR device, from the plurality of XR devices, based on the XR device being associated with a shortest distance for resolving the item that is misplaced. In other words, the server may select the XR device based on a current location of the XR device in relation to the misplaced location associated with the item and the appropriate location for the item. As a result, when the server is optimized to reduce employee effort, the server may select one of the XR devices (and associated user) to resolve the item that is misplaced.

As shown in FIG. 1B, and by reference number 114, the server may transmit, to the XR device, a request to resolve the item that is misplaced in the physical retail store. The request may indicate the misplaced location associated with the item. The request may include the identity associated with the item. The request may indicate the appropriate location for the item. In some implementations, the XR device may receive the request based on the item that is misplaced being included in the list of items to be purchased by the user of the XR device. The XR device may receive the request based on the misplaced location associated with the item and/or the appropriate location for the item being within a certain distance from the location of the item on the list of items to be purchased by the user of the XR device. The XR device may receive the request based on the current location of the XR device in relation to the misplaced location associated with the item and/or the appropriate location for the item.

As shown by reference number 116, the XR device may provide, via an interface of the XR device, a notification of the request. The XR device may provide the notification of the request via a display interface, and/or the XR device may provide the notification of the request via an audio interface. In other words, the notification may be displayed and/or verbally indicated via the interface of the XR device. The notification may include an option to accept the request and an option to deny the request. The notification may ask whether the user wants to pick up the item at the misplaced location and add the item to the shopping cart, which may be based on the list of items to be purchased by the user of the XR device. The notification may ask whether the user wants to pick up the item at the misplaced location and drop off the item at the appropriate location. The notification may indicate the misplaced location and/or the appropriate location.

In some implementations, the notification may indicate an incentive for accepting the request. The incentive may include a discount associated with purchasing the item. For example, when the notification asks whether the user wants to pick up the item at the misplaced location and add the item to the shopping cart, fulfilling the request may result in the item being discounted. The discount may be subjected to an upper limit. The incentive may include a coupon. The coupon may be associated with a specific item. The incentive may include a store credit, which the user may use towards a future transaction. The incentive may include reward points, such that when a certain number of reward points are achieved, the user may be provided with a certain perk.

As shown by reference number 118, the XR device may receive, via the interface, an indication that the request has been accepted. The XR device may receive the indication via a voice interface. For example, the user may verbally indicate “Yes” or “No” as to whether the user wants to accept the request. The XR device may receive the indication via a selection-based interface. For example, the XR device may receive, via the selection-based interface, the indication based on hand movements of the user (e.g., hand motions and/or finger motions) or via hand controllers.

As shown by reference number 120, the XR device may transmit, to the server, an indication that the request has been accepted. The server may update the list of misplaced items to indicate that the item is currently being attended to. For example, the server may change, on the list of misplaced items, a status of the item from “misplaced” to “in progress”.

Alternatively, the XR device may transmit, to the server, an indication that the request has been denied, in which case the server may transmit the request to another XR device. In other words, the server may select another XR device based on lists of items to be purchased by users and/or current locations of XR devices in the physical retail store. The server may continue transmitting the request to other XR devices until one of the XR devices accepts the request.

As shown by reference number 122, the server may transmit, to an employee system associated with the physical retail store, a notification that the item has been misplaced in the physical retail store for a period of time that satisfies a threshold. In other words, when the request is not accepted by another XR device within the period of time that satisfies the threshold, the server may transmit the request to the employee system, such that an employee of the physical retail store may resolve the item that is misplaced.

As shown in FIG. 1C, and by reference number 124, the XR device may retrieve, from the server, store mapping information associated with the physical retail store. The store mapping information may indicate a map of store aisles and corresponding items that are available for sale in the store aisles. The map may indicate, for a particular aisle, shelf numbers associated with that particular aisle. A given shelf number may hold a certain number of items. The XR device may receive the store mapping information from the server prior to arriving at the physical retail store. For example, the server may determine that the user associated with the XR device is planning to visit the physical retail store in the next hour, and one of the items included in the list of items associated with the user is the item that is misplaced, or one of the items included in the list of items is located close to the misplaced location. In this case, the server may transmit the store mapping information before the XR device arrives at the store. Alternatively, the XR device may receive the store mapping information from the server after the XR device arrives at the physical retail store. For example, the server may determine that the XR device is currently located close to the misplaced location, and only at this point the server may transmit the store mapping information to the XR device.

As shown by reference number 126, the XR device may determine, using a camera of the XR device, a current location within the physical retail store. The XR device may also determine the current location based on a global positioning system (GPS) or radio frequency (RF) location (e.g., a beacon). The current location may be associated with the XR device and/or the user wearing (or carrying) the XR device. The XR device, based on object recognition or other related techniques employed by the camera, may determine that the user is in a particular area of the physical retail store (e.g., an entryway or a particular aisle). When using object recognition, the XR device may detect an entryway sign, aisle sign numbers, etc. to determine the current location within the physical retail store.

As shown by reference number 128, the XR device may provide, via the interface, an in-store navigation path to direct the user via overlayed audio-visual cues to the misplaced location associated with the item. The overlayed audio-visual cues may direct the user from the current location to the misplaced location associated with the item to pick up the item. The overlayed audio-visual cues may include audio commands (e.g., walk to aisle 3 to pick up the misplaced item) to direct the user to the misplaced location to pick up the item. The overlayed audio-visual cues may include visual directional signs (e.g., turn right or turn left) to direct the user. The overlayed audio-visual cues may be presented via a speaker of the XR device and/or a display of the XR device. Further, the XR device may provide, via the interface, the in-store navigation path to direct the user via the overlayed audio-visual cues from the misplaced location to the appropriate location to drop off the item. The XR device may provide the in-store navigation path to only the misplaced location or to both the misplaced location and the appropriate location depending on whether the user intends to purchase the misplaced item or put the misplaced item back at the appropriate location. The XR device may determine the in-store navigation path based on the store mapping information, which may provide necessary information for the XR device to determine which turns, movements, etc. are needed to direct the user from the current location to the misplaced location, and possibly to the appropriate location for the item.

As shown in FIG. 1D, and by reference number 130, the XR device may detect, via the camera, that the item has been added to a shopping cart (e.g., the user physically places the item into the shopping cart). The camera may use object recognition or other related techniques, such that when the user picks up the item, the camera may scan the item and determine that the item corresponds to the misplaced item indicated in the request from the server.

As shown by reference number 132, the XR device may transmit, to the server, an indication that the item has been added to the shopping cart and is no longer at the misplaced location. Alternatively, the XR device may transmit, to the server, an indication that the item has been moved back to the appropriate location and is no longer at the misplaced location.

As shown by reference number 134, after receiving the indication that the item has been added to the shopping cart and is no longer at the misplaced location, the XR device may update the list of misplaced items. The XR device may remove the item from the list of misplaced items. Alternatively, the XR device may change the status of the item to reflect that the item has been resolved.

As an example, the XR device may provide, via the interface, the in-store navigation path for directing the user via the overlayed audio-visual cues from the current location to a misplaced location associated with a banana (e.g., aisle 1). The XR device may further provide, via the interface, the in-store navigation path for directing the user via the overlayed audio-visual cues from the misplaced location associated with the banana to an appropriate location associated with the banana (e.g., aisle 2). When the banana is placed in a shopping cart, a camera of the XR device may detect that the banana has been added to the shopping cart, and then transmit the indication to the server. The indication may indicate that the banana has been added to the shopping cart and is no longer misplaced. The server may update the list of misplaced items to reflect that the banana is no longer misplaced in the physical retail store.

In some implementations, the server may update a rating of the user that resolved the misplacement of the item. For example, the rating of the user may be increased based on the user resolving the misplacement of the item. User ratings may influence whether users receive requests to resolve items (and incentives for resolving the items). Users with relatively high user ratings may be more likely to receive requests to resolve items. Users with relatively high user ratings may be more likely to receive incentives for resolving the items.

As indicated above, FIG. 1 is provided as an example. Other examples may differ from what is described with regard to FIG. 1.

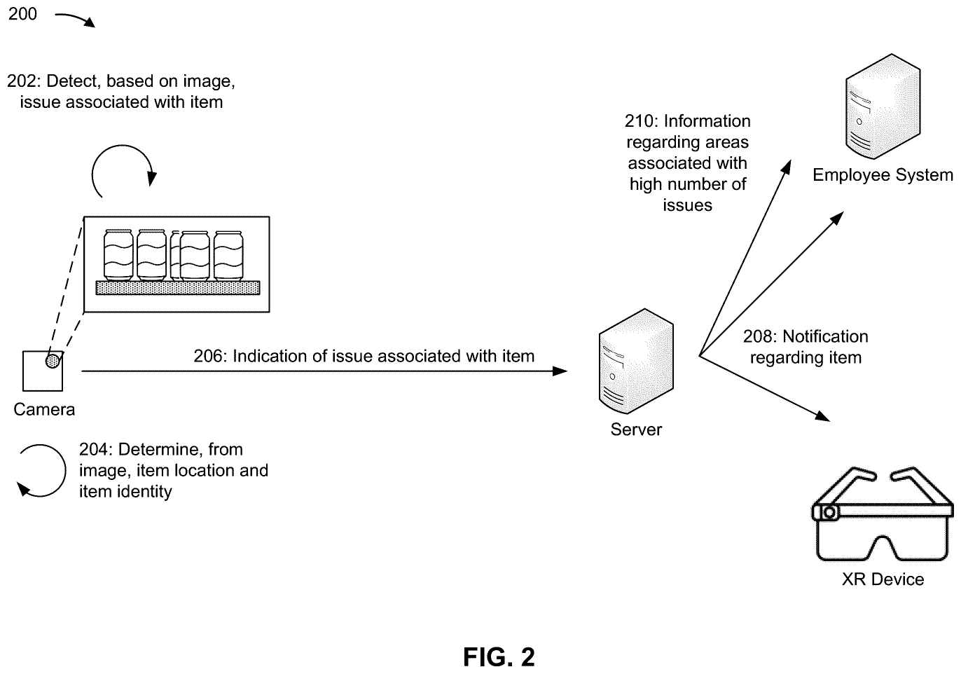

FIG. 2 is a diagram illustrating an example 200 related to resolving misplaced items in physical retail stores. As shown in FIG. 2, example 200 includes a camera, an XR device, a server, and an employee system. These devices are described in more detail in connection with FIGS. 5 and 6.

As shown by reference number 202, the camera may detect, based on an image captured by the camera, an issue associated with an item that is in a field of view of the camera. The item may be a grocery item, apparel, electronics, or any other item that may be purchased at a physical retail store. The issue may involve the item being misplaced in the physical retail store (e.g., moved to a shelf that is not intended to hold the item and instead holds other types of items). The issue may involve the item not being easily visible. For example, the item may be on an appropriate shelf, but the item may be pushed to a back of the shelf, such that the item may not be easily visible to customers. The camera may look at multiple time-lapsed images of the shelf, which may show a progression of the issue involving the item.

As shown by reference number 204, the camera may determine, from the image, an item location associated with the item. The item location may relate to a location at which the issue occurred. The item location may be a misplaced location when the issue involves the item being misplaced. The camera may determine, from the image, an identity associated with the item.

As shown by reference number 206, the camera may transmit, to the server, an indication of the issue associated with the item. For example, the indication may indicate whether the item has been misplaced, or whether the item is not readily visible or accessible on a shelf of the physical retail store (e.g., the item has been moved to the back of the shelf). The indication may include the item location and the identity associated with the item.

As shown by reference number 208, the server may receive the indication of the issue associated with the item, and the server may determine whether to transmit the indication of the issue to the XR device or the employee system, where the XR device may be associated with a customer that is shopping at the physical retail store and the employee system is associated with an employee of the physical retail store. The server may transmit the indication of the issue to the XR device or to the employee system depending on the issue associated with the item. For example, when the item is misplaced, the server may transmit the indication to the XR device, as a user associated with the XR device may be well suited for resolving the issue. When the item has been moved to the back of the shelf, the server may transmit the indication to the employee system, since the employee associated with the employee system may be better suited for handling or rearranging the item on the shelf, as opposed to the user associated with the XR device. Depending on the type of issue, the server may transmit the indication to the XR device or the employee system.

In some implementations, the server may transmit the indication of the issue to a second XR device associated with the employee. The employee may use the second XR device to resolve the issue with the item. For example, the second XR device may provide, via an interface of the second XR device, the item location. In some cases, the second XR device may provide, via the interface, an appropriate location of the item when the item has been misplaced. In this case, the employee system may be the second XR device.

In some implementations, the server may determine, based on the indication of the issue received from the camera, an identity of a person that misplaced the item. For example, the camera may indicate the identity of the person in the indication of the issue. The server may determine whether the identity of the person corresponds to a customer of the physical retail store or an employee of the physical retail store. The server may evaluate the rights of the person that misplaced the item. When the identity of the person corresponds to the employee of the physical retail store, the server may not take any action or the server may transmit, to the employee system, an enquiry requesting additional information. The server may transmit the enquiry after a set delay (e.g., 15 minutes), during which time the misplacement of the item does not seem to be resolved. In some cases, the employee may indicate, via the employee system, that the item has been properly moved to another location (e.g., the employee may have reshuffled certain items in the physical retail store). In this case, the movement of the item may not actually result in the item being misplaced. The server may tag the item as not being misplaced, and the server may update store mapping information to reflect the new location associated with the item, which may prevent the item from being mistakenly flagged as being misplaced in the future.

As shown by reference number 210, the server may transmit, to the employee system, information regarding areas of the physical retail store that are more prone to issues. The server may collect information regarding the areas of the physical retail store that are associated with a quantity of misplaced items or a quantity of less accessible items that satisfies a threshold. The server may determine which areas of the physical retail store are associated with relatively high numbers of issues. The server may make this determination in a periodic manner (e.g., once per day). The server may transmit the information to the employee system associated with the physical retail store. An employee associated with the employee system may use the information to determine which areas of the physical retail store require additional employee manpower to clean up the areas. The information may be used to devise strategies regarding ways to

As indicated above, FIG. 2 is provided as an example. Other examples may differ from what is described with regard to FIG. 2.

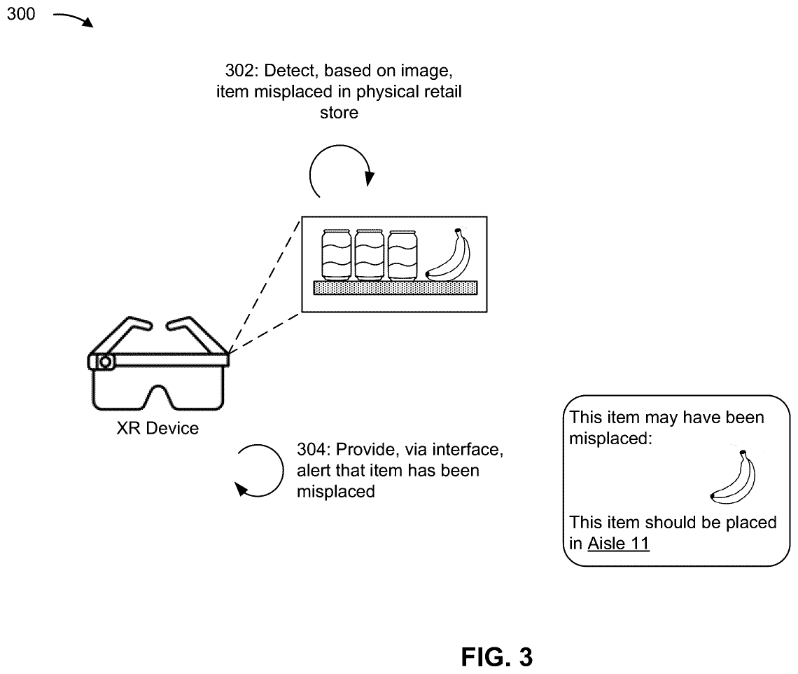

FIG. 3 is a diagram illustrating an example 300 related to resolving misplaced items in physical retail stores. As shown in FIG. 3, example 300 includes an XR device. This device is described in more detail in connection with FIGS. 5 and 6.

As shown by reference number 302, the XR device may detect, via a camera of the XR device and based on an image captured by the camera, that an item in a field of view of the camera has been misplaced in a physical retail store. A user wearing (or carrying) the XR device may intentionally or unintentionally misplace the item on a shelf of the physical retail store. The camera of the XR device may detect, in near real-time, that the item has been misplaced. The camera may detect that the item has been misplaced on the shelf based on a difference between the item and surrounding items on the shelf.

As shown by reference number 304, the XR device may provide, via the interface, an alert that the item has been misplaced. The alert may indicate an appropriate location for the item, which the XR device may determine using store mapping information received from a server. As a result, as soon as the user misplaces the item, the user may be notified to resolve the issue, which may prevent the item from sitting in a misplaced location for an inordinate amount of time. Further, the near real-time alert may encourage the customer to exhibit proper behavior when shopping at the physical retail store.

As indicated above, FIG. 3 is provided as an example. Other examples may differ from what is described with regard to FIG. 3.

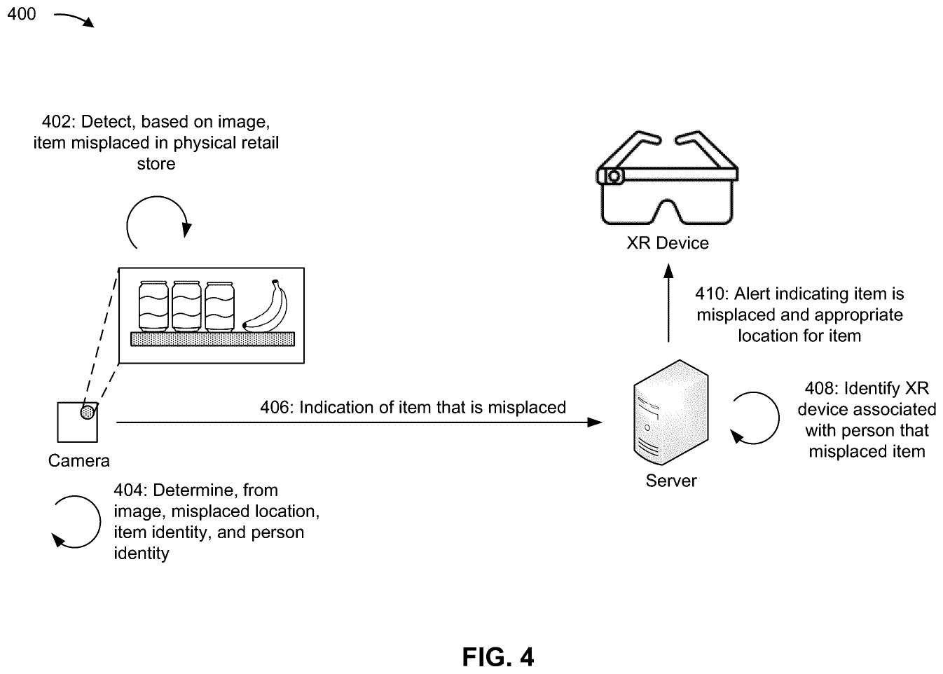

FIG. 4 is a diagram illustrating an example 400 related to resolving misplaced items in physical retail stores. As shown in FIG. 4, example 400 includes a camera, an XR device, and a server. These devices are described in more detail in connection with FIGS. 5 and 6.

As shown by reference number 402, a camera in a physical retail store may detect, based on an image captured by the camera, that an item in a field of view of the camera has been misplaced in a physical retail store.

As shown by reference number 404, the camera may determine, from the image, a misplaced location associated with the item. The camera may determine, from the image, an identity associated with the item. The camera may determine, from the image, an identity of a person that misplaced the item.

As shown by reference number 406, the camera may transmit, to the server, an indication that the item has been misplaced. The indication may indicate the misplaced location associated with the item. The indication may indicate the identity associated with the item. The indication may indicate the identity of the person that misplaced the item.

As shown by reference number 408, the server may identify the XR device associated with the person that misplaced the item. The server may determine the XR device based on the identity of the person that misplaced the item. The server may maintain a listing of person identities and corresponding XR device identities. As a result, based on the indication received from the camera, the server may determine a corresponding XR device identity.

As shown by reference number 410, the server may transmit, to the XR device, an alert indicating that the alert has been misplaced and an appropriate location for the item. In this case, the person that misplaced the item may receive the alert to resolve the misplacement of the item. The person may accept or decline, via an interface of the XR device, to resolve the misplacement of the item. However, in some cases, declining to resolve the misplacement of the item may negatively impact a user rating associated with the person. When the user rating satisfies a threshold (e.g., crosses below a threshold), the person may lose certain privileges associated with shopping at the physical retail store.

As indicated above, FIG. 4 is provided as an example. Other examples may differ from what is described with regard to FIG. 4.

FIG. 5 is a diagram of an example environment 500 in which systems and/or methods described herein may be implemented. As shown in FIG. 5, environment 500 may include one or more cameras 505, one or more XR devices 510, a server 515, an employee system 520, and a network 525. Devices of environment 500 may interconnect via wired connections, wireless connections, or a combination of wired and wireless connections.

A camera 505 may be capable of receiving, generating, storing, processing, providing, and/or routing information associated with resolving misplaced items in physical retail stores, as described elsewhere herein. The camera 505 may be a smart camera capable of taking images of items in a physical retail store. The camera 505 may be a fixed camera (e.g., mounted to a shelf) or a moving camera. The camera 505 may be part of a network of cameras which are installed throughout the physical retail store. The camera 505 may be capable of performing object recognition or similar techniques on images captured by the camera 505. The camera 505 may include a DLA, which may enable the camera 505 to process the images captured by the camera 505. The camera 505 may include a transceiver to communicate with the server 515.

An XR device 510 may be capable of receiving, generating, storing, processing, providing, and/or routing information associated with resolving misplaced items in physical retail stores, as described elsewhere herein. The XR device 510 may be a head-mounted device (or headset) or a mobile device. The XR device 510 may provide XR capabilities, which may include AR, MR, and/or VR. The XR device 510 may include various types of hardware, such as processors, sensors, cameras, input devices, and/or displays. The sensors may include accelerometers, gyroscopes, magnetometers, and/or eye-tracking sensors. The XR device 510 may include an optical head-mounted display, which may allow information to be superimposed onto a field of view.

The server 515 includes one or more devices capable of receiving, generating, storing, processing, providing, and/or routing information associated with resolving misplaced items in physical retail stores, as described elsewhere herein. The server 515 may include a communication device and/or a computing device. For example, the server 515 may be an application server, a client server, a web server, a database server, a host server, a proxy server, a virtual server (e.g., executing on computing hardware), or a server in a cloud computing system. In some implementations, the server 515 includes computing hardware used in a cloud computing environment.

The employee system 520 includes one or more devices capable of receiving, generating, storing, processing, providing, and/or routing information associated with resolving misplaced items in physical retail stores, as described elsewhere herein. The employee system 520 may include a communication device and/or a computing device. For example, the employee system 520 may include a wireless communication device, a phone such as a smart phone, a mobile phone, a user equipment, a laptop computer, a tablet computer, a desktop computer, or a similar type of device. The employee system 520 may be on-premise of the physical retail store. The employee system 520 may include an interface to provide notifications regarding items in the physical retail store.

The network 525 includes one or more wired and/or wireless networks. For example, the network 525 may include a cellular network, a public land mobile network, a local area network, a wide area network, a metropolitan area network, a telephone network, a private network, the Internet, and/or a combination of these or other types of networks. The network 525 enables communication among the devices of environment 500.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

FIG. 6 is a diagram of example components of a device 600 associated with resolving misplaced items in physical retail stores. Device 600 may correspond to camera 505, XR device 510, server 515, and/or employee system 520. In some implementations, camera 505, XR device 510, server 515, and/or employee system 520 may include one or more devices 600 and/or one or more components of device 600. As shown in FIG. 6, device 600 may include a bus 610, a processor 620, a memory 630, an input component 640, an output component 650, and a communication component 660.

Bus 610 may include one or more components that enable wired and/or wireless communication among the components of device 600. Bus 610 may couple together two or more components of FIG. 6, such as via operative coupling, communicative coupling, electronic coupling, and/or electric coupling. Processor 620 may include a central processing unit, a graphics processing unit, a microprocessor, a controller, a microcontroller, a digital signal processor, a field-programmable gate array, an application-specific integrated circuit, and/or another type of processing component. Processor 620 is implemented in hardware, firmware, or a combination of hardware and software. In some implementations, processor 620 may include one or more processors capable of being programmed to perform one or more operations or processes described elsewhere herein.

Memory 630 may include volatile and/or nonvolatile memory. For example, memory 630 may include random access memory (RAM), read only memory (ROM), a hard disk drive, and/or another type of memory (e.g., a flash memory, a magnetic memory, and/or an optical memory). Memory 630 may include internal memory (e.g., RAM, ROM, or a hard disk drive) and/or removable memory (e.g., removable via a universal serial bus connection). Memory 630 may be a non-transitory computer-readable medium. Memory 630 stores information, instructions, and/or software (e.g., one or more software applications) related to the operation of device 600. In some implementations, memory 630 may include one or more memories that are coupled to one or more processors (e.g., processor 620), such as via bus 610.

Input component 640 enables device 600 to receive input, such as user input and/or sensed input. For example, input component 640 may include a touch screen, a keyboard, a keypad, a mouse, a button, a microphone, a switch, a sensor, a global positioning system sensor, an accelerometer, a gyroscope, and/or an actuator. Output component 650 enables device 600 to provide output, such as via a display, a speaker, and/or a light-emitting diode. Communication component 660 enables device 600 to communicate with other devices via a wired connection and/or a wireless connection. For example, communication component 660 may include a receiver, a transmitter, a transceiver, a modem, a network interface card, and/or an antenna.

Device 600 may perform one or more operations or processes described herein. For example, a non-transitory computer-readable medium (e.g., memory 630) may store a set of instructions (e.g., one or more instructions or code) for execution by processor 620. Processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry is used instead of or in combination with the instructions to perform one or more operations or processes described herein. Additionally, or alternatively, processor 620 may be configured to perform one or more operations or processes described herein. Thus, implementations described herein are not limited to any specific combination of hardware circuitry and software.

The number and arrangement of components shown in FIG. 6 are provided as an example. Device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

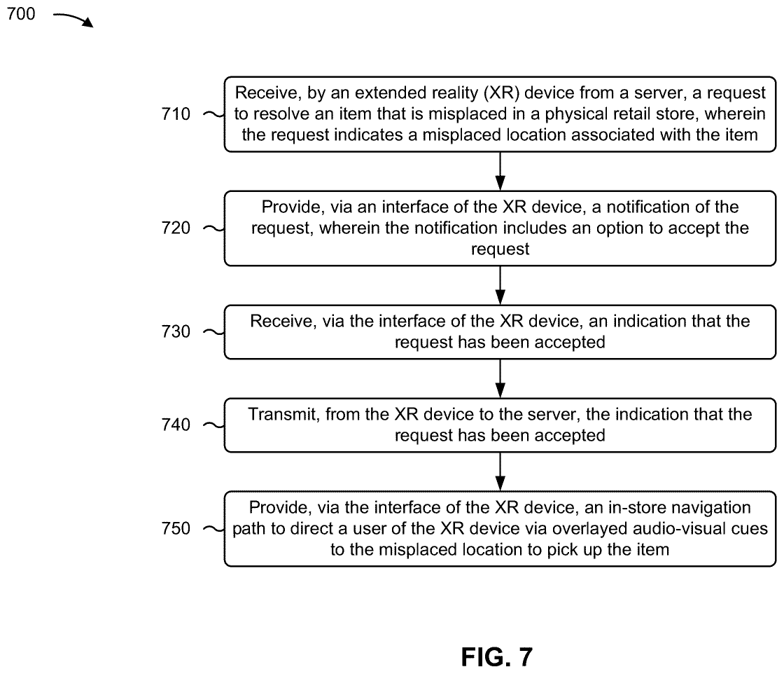

FIG. 7 is a flowchart of an example method 700 associated with resolving misplaced items in physical retail stores. In some implementations, an XR device (e.g., XR device 510) may perform or may be configured to perform one or more process blocks of FIG. 7. In some implementations, another device or a group of devices separate from or including the XR device (e.g., camera 505, server 515, and/or employee system 520) may perform or may be configured to perform one or more process blocks of FIG. 7. Additionally, or alternatively, one or more components of the XR device (e.g., processor 620, memory 630, input component 640, output component 650, and/or communication component 660) may perform or may be configured to perform one or more process blocks of FIG. 7.

As shown in FIG. 7, the method 700 may include receiving, by the XR device from the server, a request to resolve an item that is misplaced in a physical retail store, wherein the request indicates a misplaced location associated with the item (block 710). As further shown in FIG. 7, the method 700 may include providing, via an interface of the XR device, a notification of the request, wherein the notification includes an option to accept the request (block 720). As further shown in FIG. 7, the method 700 may include receiving, via the interface of the XR device, an indication that the request has been accepted (block 730). As further shown in FIG. 7, the method 700 may include transmitting, from the XR device to the server, the indication that the request has been accepted (block 740). As further shown in FIG. 7, the method 700 may include providing, via the interface of the XR device, an in-store navigation path to direct a user of the XR device via overlayed audio-visual cues to the misplaced location to pick up the item (block 750).

Although FIG. 7 shows example blocks of a method 700, in some implementations, the method 700 may include additional blocks, fewer blocks, different blocks, or differently arranged blocks than those depicted in FIG. 7. Additionally, or alternatively, two or more of the blocks of the method 700 may be performed in parallel. The method 700 is an example of one method that may be performed by one or more devices described herein. These one or more devices may perform or may be configured to perform one or more other methods based on operations described herein, such as the operations described in connection with FIGS. 1A-1D and 2-4.

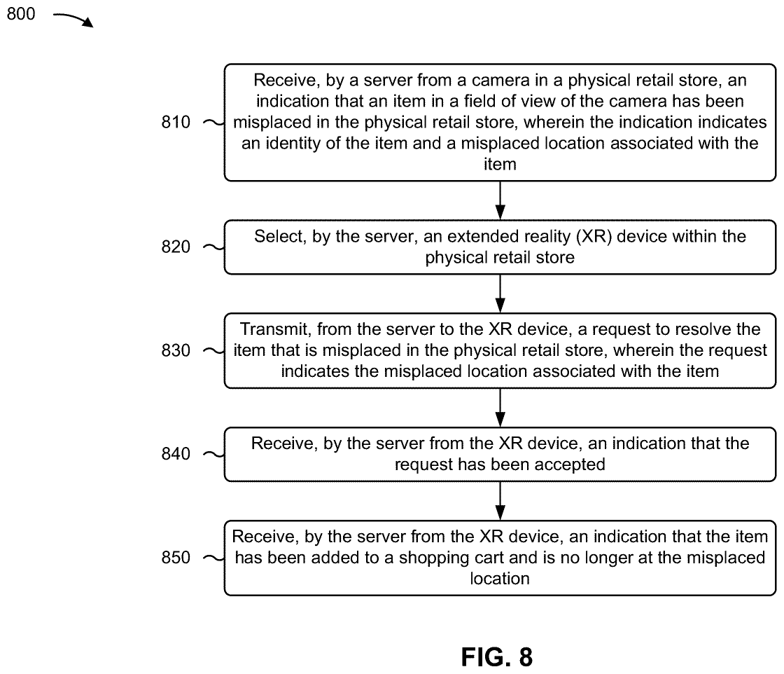

FIG. 8 is a flowchart of an example method 800 associated with resolving misplaced items in physical retail stores. In some implementations, a server (e.g., server 515) may perform or may be configured to perform one or more process blocks of FIG. 8. In some implementations, another device or a group of devices separate from or including the server (e.g., camera 505, XR device 510, and/or employee system 520) may perform or may be configured to perform one or more process blocks of FIG. 8. Additionally, or alternatively, one or more components of the server (e.g., processor 620, memory 630, input component 640, output component 650, and/or communication component 660) may perform or may be configured to perform one or more process blocks of FIG. 8.

As shown in FIG. 8, the method 800 may include receiving, by the server from a camera in a physical retail store, an indication that an item in a field of view of the camera has been misplaced in the physical retail store, wherein the indication indicates an identity of the item and a misplaced location associated with the item (block 810). As further shown in FIG. 8, the method 800 may include selecting, by the server, an XR device within the physical retail store (block 820). As further shown in FIG. 8, the method 800 may include transmitting, from the server to the XR device, a request to resolve the item that is misplaced in the physical retail store, wherein the request indicates the misplaced location associated with the item (block 830). As further shown in FIG. 8, the method 800 may include receiving, by the server from the XR device, an indication that the request has been accepted (block 840). As further shown in FIG. 8, the method 800 may include receiving, by the server from the XR device, an indication that the item has been added to a shopping cart and is no longer at the misplaced location (block 850).

Although FIG. 8 shows example blocks of a method 800, in some implementations, the method 800 may include additional blocks, fewer blocks, different blocks, or differently arranged blocks than those depicted in FIG. 8. Additionally, or alternatively, two or more of the blocks of the method 800 may be performed in parallel. The method 800 is an example of one method that may be performed by one or more devices described herein. These one or more devices may perform or may be configured to perform one or more other methods based on operations described herein, such as the operations described in connection with FIGS. 1A-1D and 2-4.

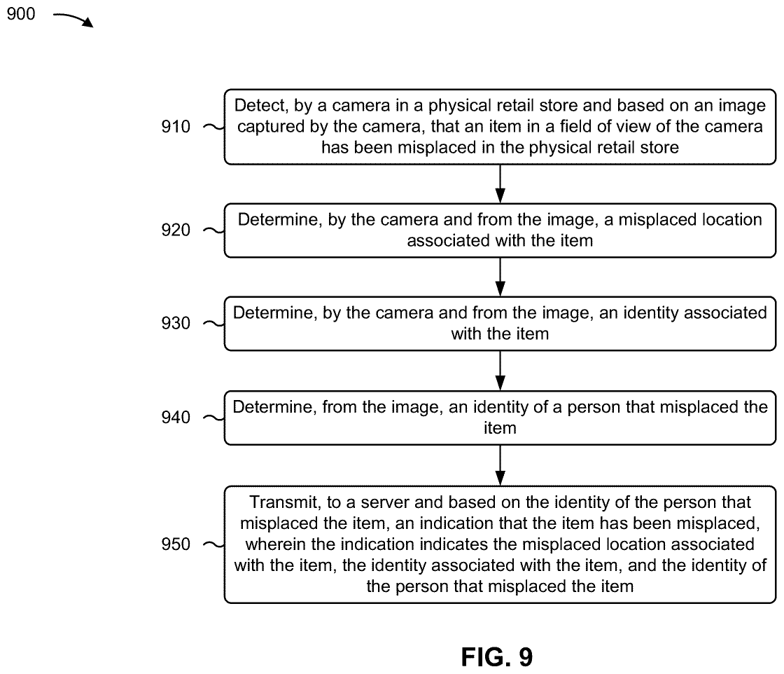

FIG. 9 is a flowchart of an example method 900 associated with resolving misplaced items in physical retail stores. In some implementations, a camera (e.g., camera 505) may perform or may be configured to perform one or more process blocks of FIG. 9. In some implementations, another device or a group of devices separate from or including the camera (e.g., XR device 510, server 515, and/or employee system 520) may perform or may be configured to perform one or more process blocks of FIG. 9. Additionally, or alternatively, one or more components of the camera (e.g., processor 620, memory 630, input component 640, output component 650, and/or communication component 660) may perform or may be configured to perform one or more process blocks of FIG. 9.

As shown in FIG. 9, the method 900 may include detecting, by the camera in a physical retail store and based on an image captured by the camera, that an item in a field of view of the camera has been misplaced in the physical retail store (block 910). As further shown in FIG. 9, the method 900 may include determining, by the camera and from the image, a misplaced location associated with the item (block 920). As further shown in FIG. 9, the method 900 may include determining, by the camera and from the image, an identity associated with the item (block 930). As further shown in FIG. 9, the method 900 may include determining, from the image, an identity of a person that misplaced the item (block 940). As further shown in FIG. 9, the method 900 may include transmitting, to a server and based on the identity of the person that misplaced the item, an indication that the item has been misplaced, wherein the indication includes the misplaced location associated with the item, the identity associated with the item, and the identity of the person that misplaced the item (block 950).

Although FIG. 9 shows example blocks of a method 900, in some implementations, the method 900 may include additional blocks, fewer blocks, different blocks, or differently arranged blocks than those depicted in FIG. 9. Additionally, or alternatively, two or more of the blocks of the method 900 may be performed in parallel. The method 900 is an example of one method that may be performed by one or more devices described herein. These one or more devices may perform or may be configured to perform one or more other methods based on operations described herein, such as the operations described in connection with FIGS. 1A-1D and 2-4.

In some implementations, an extended reality (XR) device includes one or more components configured to: receive, from a server, a request to resolve an item that is misplaced in a physical retail store, wherein the request indicates a misplaced location associated with the item; provide, via an interface, a notification of the request, wherein the notification includes an option to accept the request; receive, via the interface, an indication that the request has been accepted; transmit, to the server, the indication that the request has been accepted; and provide, via the interface, an in-store navigation path to direct a user of the XR device via overlayed audio-visual cues to the misplaced location to pick up the item.

In some implementations, a server includes one or more components configured to: receive, from a camera in a physical retail store, an indication that an item in a field of view of the camera has been misplaced in the physical retail store, wherein the indication indicates an identity of the item and a misplaced location associated with the item; select an extended reality (XR) device within the physical retail store; transmit, to the XR device, a request to resolve the item that is misplaced in the physical retail store, wherein the request indicates the misplaced location associated with the item; receive, from the XR device, an indication that the request has been accepted; and receive, from the XR device, an indication that the item has been added to a shopping cart and is no longer at the misplaced location.

In some implementations, a camera in a physical retail store includes one or more components configured to: detect, based on an image captured by the camera, that an item in a field of view of the camera has been misplaced in the physical retail store; determine, from the image, a misplaced location associated with the item; determine, from the image, an identity associated with the item; determine, from the image, an identity of a person that misplaced the item; and transmit, to a server and based on the identity of the person that misplaced the item, an indication that the item has been misplaced, wherein the indication includes the misplaced location associated with the item, the identity associated with the item, and the identity of the person that misplaced the item.

The foregoing disclosure provides illustration and description but is not intended to be exhaustive or to limit the implementations to the precise forms disclosed. Modifications and variations may be made in light of the above disclosure or may be acquired from practice of the implementations described herein.

The orientations of the various elements in the figures are shown as examples, and the illustrated examples may be rotated relative to the depicted orientations. The descriptions provided herein, and the claims that follow, pertain to any structures that have the described relationships between various features, regardless of whether the structures are in the particular orientation of the drawings, or are rotated relative to such orientation. Similarly, spatially relative terms, such as “below,” “beneath,” “lower,” “above,” “upper,” “middle,” “left,” and “right,” are used herein for ease of description to describe one element's relationship to one or more other elements as illustrated in the figures. The spatially relative terms are intended to encompass different orientations of the element, structure, and/or assembly in use or operation in addition to the orientations depicted in the figures. A structure and/or assembly may be otherwise oriented (rotated 90 degrees or at other orientations), and the spatially relative descriptors used herein may be interpreted accordingly. Furthermore, the cross-sectional views in the figures only show features within the planes of the cross-sections, and do not show materials behind the planes of the cross-sections, unless indicated otherwise, in order to simplify the drawings.

As used herein, the terms “substantially” and “approximately” mean “within reasonable tolerances of manufacturing and measurement.” As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. An extended reality (XR) device, comprising:
one or more components configured to:
receive, from a server, a request to resolve an item that is misplaced in a physical retail store, wherein the request indicates a misplaced location associated with the item;
provide, via an interface of the XR device, a notification of the request, wherein the notification includes an option to accept the request;
receive, via the interface, an indication that the request has been accepted;
transmit, to the server, the indication that the request has been accepted; and
provide, via the interface, an in-store navigation path to direct a user of the XR device via overlayed audio-visual cues to the misplaced location to pick up the item.

2. The XR device of claim 1, wherein the one or more components are configured to:
transmit, to the server, a list of items to be purchased at the physical retail store, wherein the request to resolve the item is received based on the item being included in the list of items to be purchased.

3. The XR device of claim 1, wherein the one or more components are configured to:
transmit, to the server, a list of items to be purchased at the physical retail store, wherein the request to resolve the item is received based on the misplaced location being within a certain distance from a location of an item on the list of items to be purchased.

4. The XR device of claim 1, wherein the request is received based on a current location of the XR device in relation to the misplaced location associated with the item.

5. The XR device of claim 1, wherein the request indicates an appropriate location for the item, and wherein the in-store navigation path is configured to direct the user via the overlayed audio-visual cues to the appropriate location to drop off the item.

6. The XR device of claim 1, wherein the one or more components are configured to:
receive, from the server, store mapping information that indicates a map of store aisles and corresponding items that are available for sale in the store aisles;
determine, using a camera of the XR device, a current location within the physical retail store; and
provide, via the interface and based on the store mapping information, the in-store navigation path to direct the user via the overlayed audio-visual cues from the current location to the misplaced location to pick up the item.

7. The XR device of claim 1, wherein the one or more components are configured to:
detect, via a camera of the XR device, that the item is added to a shopping cart; and
transmit, to the server, an indication that the item has been added to the shopping cart and is no longer at the misplaced location.

8. The XR device of claim 1, wherein the notification indicates an incentive for accepting the request, and wherein the incentive includes one of: a discount associated with purchasing the item, a coupon, a store credit, or reward points.

9. The XR device of claim 1, wherein the XR device is associated with a customer of the physical retail store or an employee of the physical retail store.

10. The XR device of claim 1, wherein the item is a first item, and wherein the one or more components are configured to:
detect, using a camera of the XR device, that a second item has been misplaced on a shelf of the physical retail store based on a difference between the second item and surrounding items on the shelf; and
provide, via the interface, an alert that the second item has been misplaced.

11. A server, comprising:
one or more components configured to:
receive, from a camera in a physical retail store, an indication that an item in a field of view of the camera has been misplaced in the physical retail store, wherein the indication indicates an identity of the item and a misplaced location associated with the item;
select an extended reality (XR) device within the physical retail store;
transmit, to the XR device, a request to resolve the item that is misplaced in the physical retail store, wherein the request indicates the misplaced location associated with the item;
receive, from the XR device, an indication that the request has been accepted; and
receive, from the XR device, an indication that the item has been added to a shopping cart and is no longer at the misplaced location.

12. The server of claim 11, wherein the one or more components are configured to:
receive, from the XR device, a list of items to be purchased at the physical retail store, wherein the XR device is selected to receive the request based on the item being included in the list of items to be purchased.

13. The server of claim 11, wherein the one or more components are configured to:
receive, from the XR device, a list of items to be purchased at the physical retail store, wherein the XR device is selected to receive the request based on the misplaced location being within a certain distance from a location of an item on the list of items to be purchased.

14. The server of claim 11, wherein the one or more components are configured to:
select the XR device based on a current location of the XR device in relation to the misplaced location associated with the item.

15. The server of claim 11, wherein the one or more components are configured to:
update a list of misplaced items at the physical retail store, maintained by the server, based on the indication, received from the camera, that the item in the field of view of the camera has been misplaced in the physical retail store; and
update the list of misplaced items based on the indication, received from the XR device, that the item has been added to the shopping cart and is no longer at the misplaced location.

16. The server of claim 11, wherein the one or more components are configured to:
determine an appropriate location for the item based on store mapping information, wherein the request indicates the appropriate location for the item.

17. The server of claim 11, wherein the indication that the item has been misplaced, as received from the camera, indicates an identity of a person that misplaced the item, and wherein the one or more components are configured to update a rating associated with the person.

18. The server of claim 11, wherein the one or more components are configured to:
transmit, to an employee system associated with the physical retail store, a notification that the item has been misplaced in the physical retail store for a period of time that satisfies a threshold.

19. The server of claim 11, wherein the request indicates an incentive for accepting the request, and wherein the incentive includes one of: a discount associated with purchasing the item, a coupon, a store credit, or reward points.

20. The server of claim 11, wherein the XR device is a first XR device, wherein the indication that the item has been misplaced, as received from the camera, indicates an identity of a person that misplaced the item, and wherein the one or more components are configured to:
identify a second XR device associated with the person that misplaced the item; and
transmit, to the second XR device, an alert indicating that the item has been misplaced and an appropriate location for the item.

21. The server of claim 11, wherein the one or more components are configured to:
collect information regarding areas of the physical retail store that are associated with a quantity of misplaced items that satisfies a threshold; and
transmit the information to an employee system associated with the physical retail store.

22. The server of claim 11, wherein the item is a first item, and wherein the one or more components are configured to:
receive, from the camera, an indication of an issue associated with a second item, wherein the issue involves the second item being misplaced on a shelf or the second item being moved to a back of the shelf; and
transmit the indication of the issue associated with the second item to the XR device or to an employee system associated with the physical retail store depending on the issue.

23. A camera in a physical retail store, comprising:
one or more components configured to:
detect, based on an image captured by the camera, that an item in a field of view of the camera has been misplaced in the physical retail store;
determine, from the image, a misplaced location associated with the item;
determine, from the image, an identity associated with the item;
determine, from the image, an identity of a person that misplaced the item; and
transmit, to a server and based on the identity of the person that misplaced the item, an indication that the item has been misplaced, wherein the indication indicates the misplaced location associated with the item, the identity associated with the item, and the identity of the person that misplaced the item.

24. The camera of claim 23, wherein the one or more components are configured to:
transmit the indication to the server based on the identity of the person corresponding to a customer of the physical retail store; or
transmit the indication to the server based on the identity of the person corresponding to an employee of the physical retail store.

25. The camera of claim 23, wherein the one or more components are configured to:
detect that the item has been misplaced on a shelf of the physical retail store based on a difference between the item and surrounding items on the shelf.
